(19) United States
(12) Patent Application Publication
(10) Pub. No.: US 2026/0301396 A1
(43) Pub. Date: Oct. 1, 2026

(54) SYSTEMS AND METHODS OF CONTEXTUAL FILTERING FOR VLM PROCESSING

(71) Applicant: NVIDIA Corporation, Santa Clara, CA (US)

(72) Inventors: Rahul RANE, Pune (IN); Vishal DHAR, Pune (IN); Hiren NAMERA, Pune (IN); Rohit SINGH, Pune (IN); Abhishek ANURAG, Pune (IN)

(73) Assignee: NVIDIA Corporation, Santa Clara, CA (US)

(21) Appl. No.: 19/097,028

(22) Filed: Apr. 1, 2025

(51) Int. Cl. G06V 10/82; G06V 10/70; G06V 10/74; G06V 10/94; G06V 20/20; G06V 20/52; G06V 20/70

(52) U.S. Cl. CPC G06V 10/82; G06V 10/761; G06V 10/768; G06V 20/70; G06V 10/95; G06V 20/20; G06V 20/52

(57) ABSTRACT

Various examples, systems, and methods are disclosed relating to contextual filtering for vision language model (VLM) processing. A system can detect a motion between a first frame of image data and a second frame of image data. A system can determine a first similarity score between the first frame and the second frame and a second similarity score between the second frame and a context for processing of the second frame. A system can generate a combined score. A system can process the second frame using one or more neural networks responsive to determining that one or more frame selection criteria are satisfied based at least on the combined score.

### BACKGROUND

Some systems process a high volume of frames for video processing tasks using one or more vision language models (VLMs). These systems select informative frames using methods such as random frame selection and uniform frame selection. However, these systems select irrelevant frames, miss frames containing contextual information, and add increased overhead by analyzing redundant or duplicate frames.

### SUMMARY

Implementations of the present disclosure relate to systems and methods of contextual filtering for vision language model (VLM) processing. Systems and methods are disclosed that utilize one or more image and/or prompt filters to generate contextually relevant image data for VLM processing. In contrast to conventional systems, such as those described above, systems and methods in accordance with the present disclosure can allow for efficient performance of video processing tasks while reducing use of computational resources being processed, stored, and/or transmitted by selecting some frames of a sequence of frames and rejecting the remaining frames in the sequence of frames.

In some aspects, the techniques described herein relate to one or more processors including one or more circuits. The one or more circuits can detect a motion between a first frame of image data and a second frame of image data. The one or more circuits can determine a first similarity score between the first frame and the second frame and a second similarity score between the second frame and a context for processing of the second frame. The one or more circuits can process the second frame using one or more neural networks responsive to determining that one or more frame selection criteria are satisfied based at least on the motion, the first similarity score, and the second similarity score.

In some implementations the one or more circuits can determine the context according to a user prompt indicative of the context.

In some implementations the one or more circuits can detect the motion between the first frame and the second frame according to an optical flow of the first frame relative to the second frame.

In some implementations the one or more circuits can retrieve the first frame as a selected frame. The one or more circuits can update the selected frame to be the second frame responsive to determining that the one or more frame selection criteria are satisfied.

In some implementations the one or more circuits can determine the first similarity score by determining, using at least one language model, a first semantic embedding of the first frame, and a second semantic embedding of the second frame. The one or more circuits can determine the first similarity score by comparing the first semantic embedding with the second semantic embedding.

In some implementations the one or more circuits can determine that the one or more frame selection criteria are satisfied based at least on assigning a higher value to relatively higher similarity between the first frame and the second frame as indicated by the first similarity score and to relatively higher similarity between the second frame and the context as indicated by the second similarity score.

In some implementations the one or more circuits can reject, in response to determining that the first similarity score is below a similarity threshold, the second frame from further processing.

In some implementations the one or more circuits can reject, in response to determining that the motion is less than a motion threshold, the second frame from further processing.

In some aspects, the techniques described herein relate to a system including one or more processors to execute operations. The one or more processors can detect a motion between a first frame of image data and a second frame of image data. The one or more processors can determine a first similarity score between the first frame and the second frame and a second similarity score between the second frame and a context for processing of the second frame. The one or more processors can process the second frame using one or more neural networks responsive to determining that one or more frame selection criteria are satisfied based at least on the motion, the first similarity score, and the second similarity score.

In some implementations, the one or more processors can determine that the one or more frame selection criteria are satisfied based at least on assigning a higher value to relatively higher similarity between the first frame and the second frame as indicated by the first similarity score and to relatively higher similarity between the second frame and the context as indicated by the second similarity score. The one or more processors can determine that the one or more frame selection criteria are satisfied based at least on generating a combined score based at least on the motion, the first similarity score, and the second similarity score. The one or more processors can determine that the one or more frame selection criteria are satisfied based at least on determining that the combined score satisfies a threshold. The one or more processors can, responsive to determining that the one or more frame selection criteria are satisfied, process the second frame using one or more neural networks.

In some aspects, the techniques described herein relate to a method. The method can include receiving, as input, a last-selected frame and a current frame. The method can include determining, using optical flow, a first score for the current frame based at least on motion between the current frame and the last-selected frame. The method can include determining a second score for the current frame based at least on a semantic similarity between the current frame and the last-selected frame. The method can include generating a combined score for the current frame based at least on the first score and the second score. The method can include selecting the current frame for further processing in response to determining that the combined score satisfies a threshold. The method can include updating the last-selected frame to be the current frame.

In some implementations, the method can include generating the combined score according to a third score for the current frame based at least on a semantic similarity between the current frame and a user input prompt. The method can include weighting one or more of the first score, the second score, and the third score.

In some implementations, the techniques described herein relate to a method, further including storing, responsive to the current frame being a first frame, the current frame in memory as a last-selected frame.

In some implementations, the techniques described herein relate to a method wherein, responsive to determining that the first score does not exceed a threshold, rejecting the current frame from further processing.

In some implementations, the techniques described herein relate to a method further including, responsive to determining that the second score does not exceed a threshold, rejecting the current frame from further processing. The method can include incrementing a count of unselected frames.

In some implementations, the techniques described herein relate to a method, wherein selecting the current frame further includes resetting a count of unselected frames to zero.

In some implementations, the techniques described herein relate to a method wherein, responsive to determining that a count of unselected frames exceeds a second threshold, selecting the current frame for further processing. The method can include resetting the count of unselected frames to zero.

In some implementations, the techniques described herein relate to a method, wherein, responsive to determining that the combined score does not satisfy the threshold and that a count of unselected frames does not exceed a second threshold, rejecting the current frame from further processing. The method can include incrementing the count of unselected frames.

### BRIEF DESCRIPTION OF THE DRAWINGS

The present systems and methods for contextual filtering for VLM processing are described in detail below with reference to the attached drawing figures, wherein:

FIG. 1A is a block diagram of a contextual filtering system, in accordance with implementing some implementations of the present disclosure;

FIG. 1B is a block diagram of a contextual filtering system, in accordance with implementing some implementations of the present disclosure;

FIG. 2 is a block diagram of a motion filtering system, in accordance with implementing some implementations of the present disclosure;

FIG. 3 is a block diagram of an image-image filtering system, in accordance with implementing some implementations of the present disclosure;

FIG. 4 is a block diagram of an image-prompt filtering system, in accordance with implementing some implementations of the present disclosure;

FIG. 5 is a block diagram of a combined scoring system, in accordance with implementing some implementations of the present disclosure;

FIG. 6 is a flow diagram of an example of a method for contextual filtering, in accordance with implementing some implementations of the present disclosure.

FIG. 7 is a flow diagram of an example of a method for contextual filtering, in accordance with implementing some implementations of the present disclosure.

FIG. 8A is a block diagram of an example generative language model system suitable for use in implementing at least some implementations of the present disclosure;

FIG. 8B is a block diagram of an example generative language model that can include a transformer encoder-decoder suitable for use in implementing at least some implementations of the present disclosure;

FIG. 8C is a block diagram of an example generative language model that can include a decoder-only transformer architecture suitable for use in implementing at least some implementations of the present disclosure;

FIG. 9 is a block diagram of an example content streaming system suitable for use in implementing some implementations of the present disclosure;

FIG. 10 is a block diagram of an example computing device suitable for use in implementing at least some implementations of the present disclosure; and

FIG. 11 is a block diagram of an example data center suitable for use in implementing at least some implementations of the present disclosure.

### DETAILED DESCRIPTION

Systems and methods are disclosed related to contextual filtering for VLM processing. For example, systems and methods as described herein can select frames by detecting a motion between a first frame of image data and a second frame of image data. The image data can be a sequence of frames. Some systems process redundant and/or duplicate frames present in a sequence of frames. This can lead to unnecessary computational costs, such as for warehouse surveillance where most frames contain little to no activity. The systems and methods described herein, however, can determine whether a plurality of frames have a motion similarity above a determined threshold. This can include determining an optical flow of the first frame of image data relative to the second frame of image data by extracting image derivatives such as spatial and temporal gradients from the image frames. The system can reject duplicated and/or redundant frames based at least on the determined motion similarity, and retain, as in the warehouse surveillance example, frames containing activity (e.g., illegal and/or unauthorized activity) useful for timely intervention.

Systems and methods in accordance with the present disclosure can select images and/or image frames by determining a semantic similarity between a last-selected frame and a current frame. Some systems select frames uniformly or randomly without considering a last-selected frame. These systems can use computational resources on uninformative frames and even miss out on key event frames, such as identification of moments in sports analysis including a goal, foul, or out-of-bounds event. Contrastingly, the systems and methods described herein can determine a semantic-level similarity between the last-selected frame and the current frame by inputting the frames through a VLM, generating embedding vectors of the frames, and using a cosine similarity on these embeddings to determine an image-image similarity score. The system can reject current frames based at least on the determined image-image similarity.

In some implementations, the system can select images and/or image frames by determining a semantic similarity between a context and a current frame. The context can be determined based on one or more input prompts. Some systems select frames uniformly or randomly without a context. These systems miss out on dynamic frame selection guidance. However, the systems and methods described herein can dynamically filter frames based at least on a prompt. This can include inputting the current frame and the context through a light or distilled VLM, and using a cosine similarity on these embeddings to determine an image-prompt similarity score. The system can reject current frames based at least on the determined image-prompt similarity.

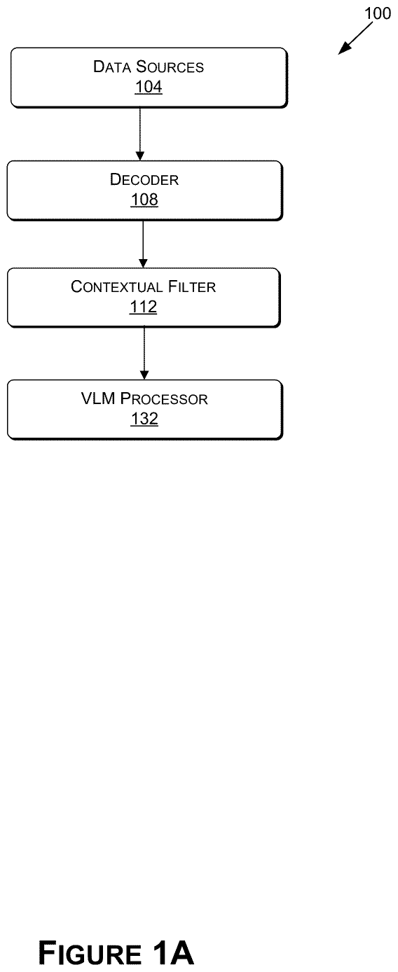

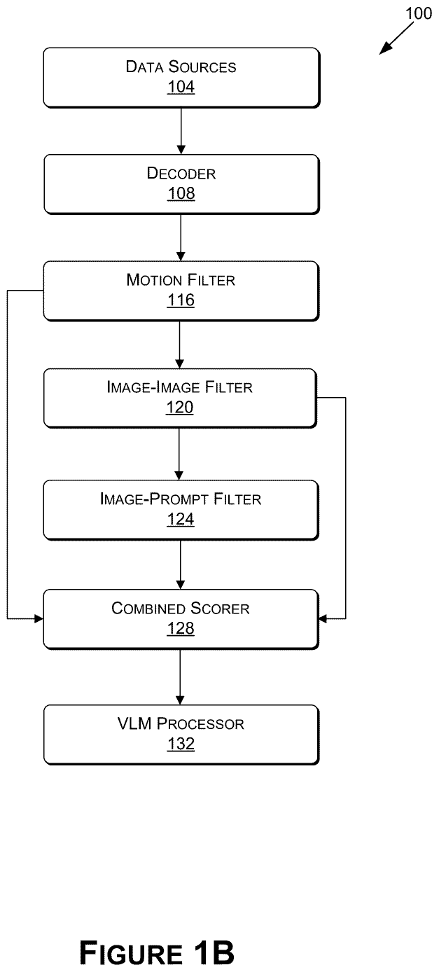

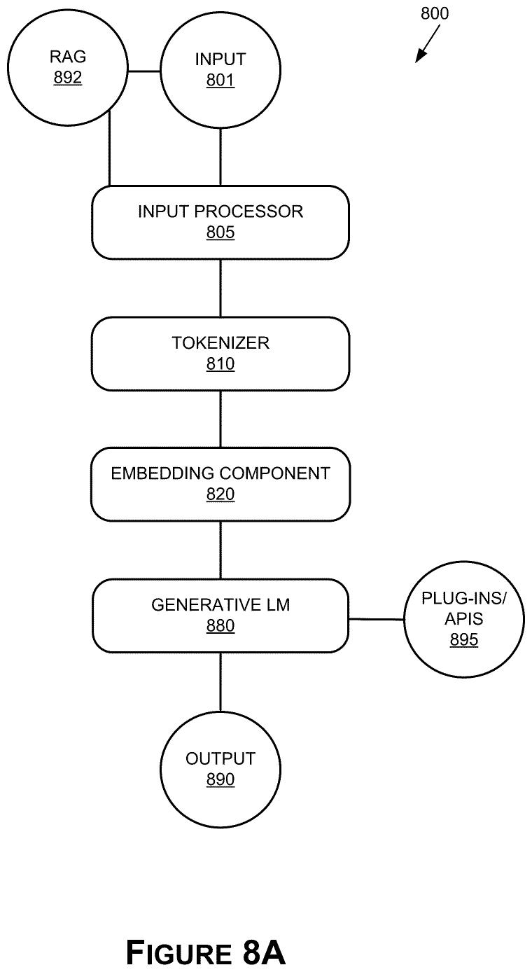

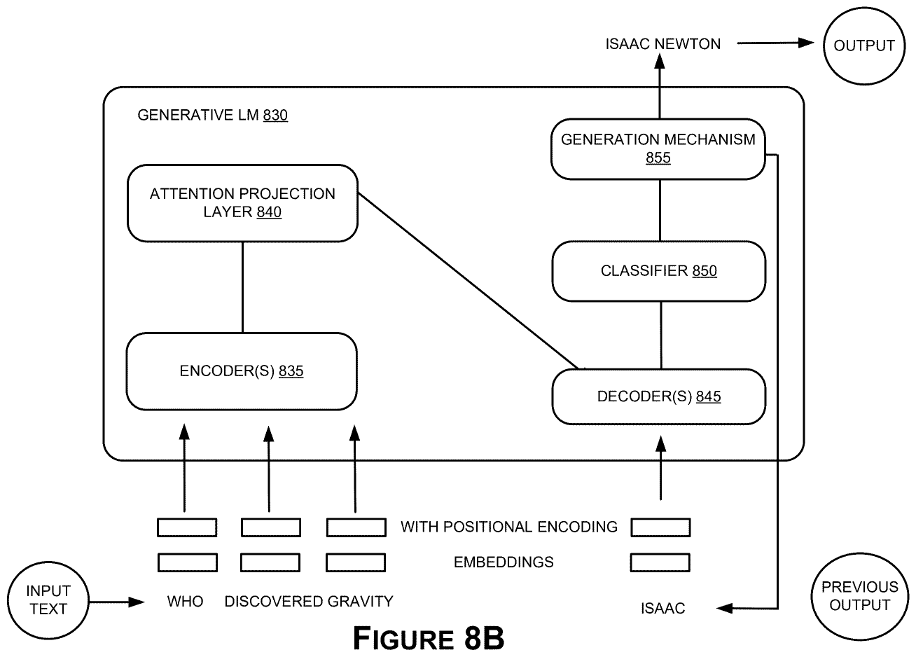

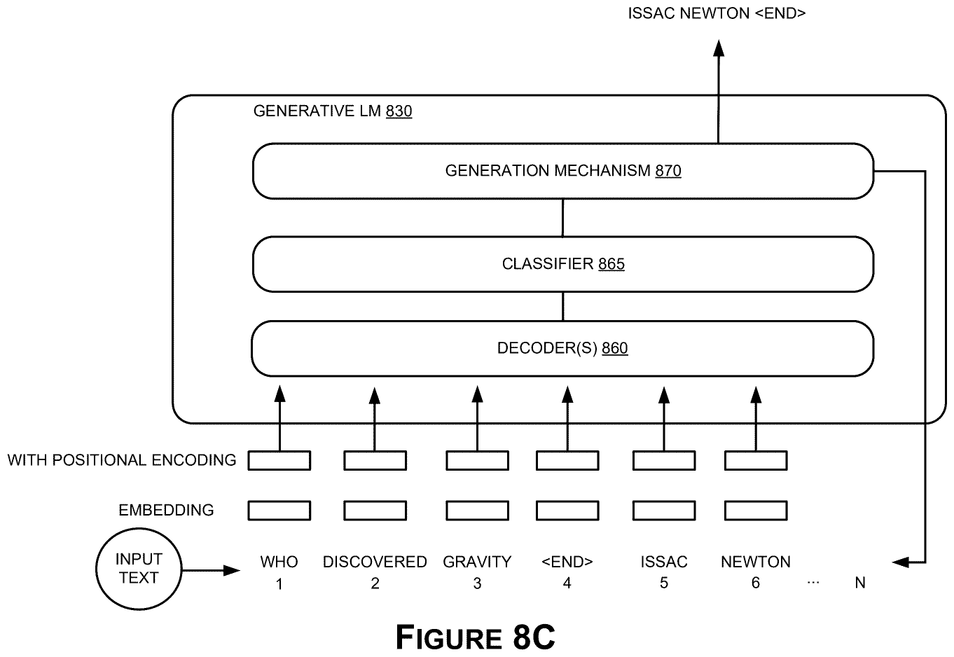

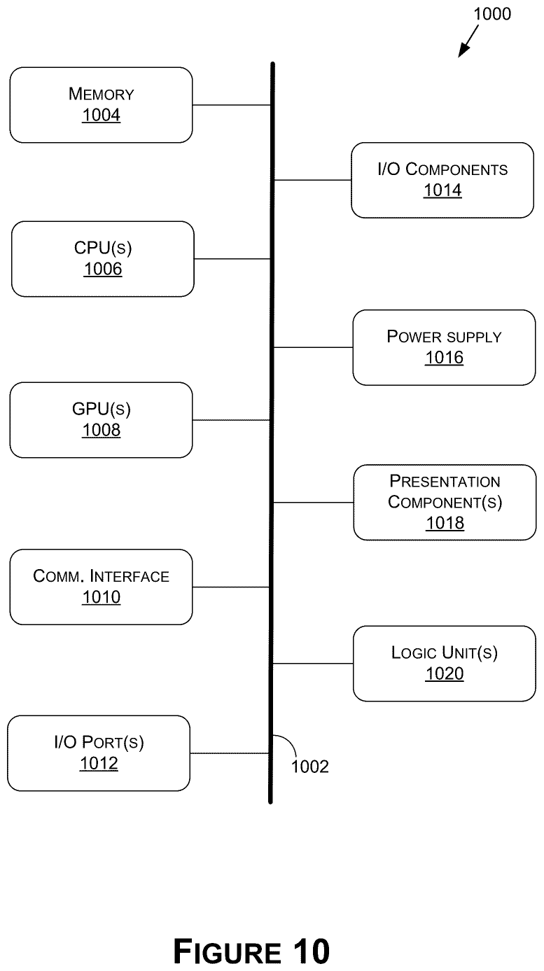

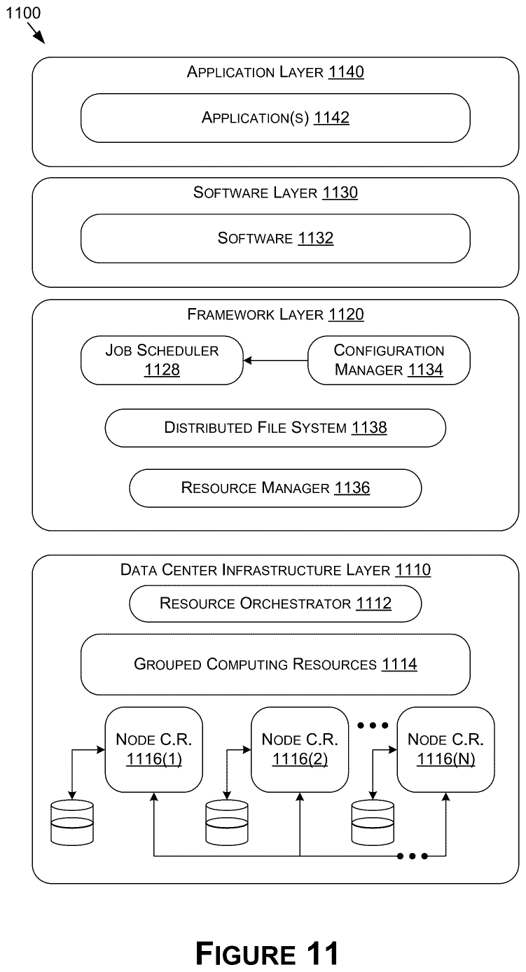

With reference to FIGS. 1A-1B, FIGS. 1A-1B show an example system 100 for contextual filtering for VLM processing, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some implementations, the system and methods described herein may be implemented using one or more generative language models (e.g., as described in FIGS. 8A-8C), one or more computing devices or components thereof (e.g., as described in FIG. 10), and/or one or more data centers or components thereof (e.g., as described in FIG. 11).

With reference to FIG. 1A, FIG. 1A is an example block diagram of a system 100 for contextual filtering for VLM processing, in accordance with some implementations of the present disclosure. The system 100 can include or be coupled with one or more data sources such as data sources 104. The data sources 104 can include or the system 100 can receive data from any of various databases, data sets, data repositories, or from a remote device via a network connection, for example. For example and without limitation, the system 100 can receive data from the data sources 104 as streaming image and/video data.

The data sources 104 can include, without limitation, data such as any one or more of text, speech, audio, image, and/or video data. Images and/or image frames (including video) of the data can correspond to one or more views of a scene captured by an image capture device (e.g., camera), or images generated computationally, such as simulated or virtual images or video (including by being modifications of images from an image capture device). The images can each include a plurality of pixels, such as pixels arranged in rows and columns. The images can include image data assigned to one or more pixels of the images, such as color, brightness, contrast, intensity, depth (e.g., for three-dimensional (3D) images), or various combinations thereof. The data can include videos and/or video data structured as a plurality of frames (e.g., image frames, video frames), such as in a sequence of frames, where each frame is assigned a time index (e.g., time step, time point) and has image data assigned to one or more pixels of the images.

The system 100 can include at least one decoder 108 to decode data into one or more images and/or image frames. The decoder 108 can receive image data from data sources 104 such as a video file input (e.g., .MP4, .MKV, .MOV) or real-time stream video (e.g., real-time streaming protocol (RTSP)). The decoder 104 can perform chunking on the video input to divide the video input into one or more chunks based at least on a predetermined chunk time (e.g., 5 minutes). The system 100 can use the one or more chunks, for example, to perform the methods described herein using multi-GPU and/or parallel processing. The decoder 104 can decode the one or more chunks into a plurality of image frames, based at least on a predetermined number of frames per second (fps).

The system 100 can include at least one contextual filter 112 to filter one or more image frames from a plurality of image frames. The contextual filter 112 can include one or more components, as described further herein. The contextual filter 112 can be used to selectively pass useful frames for further processing, e.g., by VLM processor 132, and/or filter out less useful (e.g., semantically redundant) frames; this can allow for improved tasks such as more efficient image processing and/or more effective VLM processing and/or training.

The contextual filter 112 can receive a plurality of frames. The contextual filter 112 can receive a current frame as input, for example, from the decoder 108. The plurality of frames can include a last-selected frame and a current frame, wherein the current frame, for example, is to be checked for frame selection or rejection. If there is not a last-selected frame, the default first frame can act as the last-selected frame. The contextual filter 112 can output one or more selected frames to be used, for example, for video processing and/or VLM processing.

The contextual filter 112 can retrieve a prompt, e.g., user prompt. The contextual filter 112 can retrieve the prompt as input, for example, from data sources 104, such as where the prompt is previously stored and/or maintained in one or more data sources 104, or where the contextual filter 112 can process data in the data sources 104 to determine the prompt. The prompt can include a user prompt, such as a query (e.g., text query, audio queries, multimodal query, etc.). The contextual filter 112 can receive the user prompt prior to processing the one or more frames. The prompt can include a user-provided instruction or query to guide the selection of relevant frames.

The system 100 can include at least one VLM processor 132 to receive, as input, one or more selected frames from the contextual filter 112. The VLM processor 132 can generate one or more outputs according to the one or more selected frames. The VLM processor 132 can generate, for example, a caption for the video input from data sources 104 based at least on the one or more selected frames. The VLM processor 132 can generate, additionally or alternatively, a response to one or more user prompts based at least on the one or more selected frames.

With reference to FIG. 1B, FIG. 1B is an example block diagram of the system 100 for contextual filtering for VLM processing, in accordance with some implementations of the present disclosure. The contextual filter 112 of FIG. 1A can include one or more components as described further herein.

The contextual filter 112 can include at least one motion filter 116 to determine motion, e.g., a motion score, between a plurality of frames, such as between a current frame and a last-selected frame. For example, the motion filter 116 can include one or more components as described further herein.

The motion filter 116 can receive, as input, one or more frames. The motion filter 116 can receive the one or more frames as input, for example, from the decoder 108. The one or more frames can be a current frame and a last-selected frame.

The motion filter 116 can extract optical flow points from the one or more frames representing, for example, motion between the current frame and the last-selected frame. The motion filter 116 can extract a plurality of optical flow points by applying one or more algorithms, such as PWC-Net, to the one or more frames. The motion filter 116 can generate one or more motion vectors based at least on the plurality of optical flow points. The motion filter 116 can determine a magnitude of the one or more motion vectors. The motion filter 116 can determine a motion score by aggregating the magnitude of the one or more motion vectors. The motion filter 116 can reject one or more frames based at least on the motion score and a predetermined motion threshold. For example, based at least on determining that the motion score of the current frame and the last-selected frame does not exceed the motion threshold, the motion filter 116 can reject the current frame from further processing. The one or more rejected frames can contain, for example, redundant or duplicate information.

The contextual filter 112 can include at least one image-image filter 120 to determine a semantic similarity score between a plurality of frames, such as between a current frame and a last-selected frame. The image-image filter 120 can include one or more components as described further herein. The image-image filter 120 can receive, as input, one or more frames. The image-image filter 120 can receive the one or more frames as input, for example, from the decoder 108. The one or more frames can be a current frame and a last-selected frame. In some implementations, the current frame is a current frame which was processed and not rejected by the motion filter 116, such as to have been outputted from the motion filter 116. The image-image filter 120 can obtain an embedding of any one or more image frames. The embeddings can be numerical and/or vector representations of data, such as a vector embedding of an image frame. The embeddings can provide a consistent format for comparison between data types. For example, a vector embedding of an image frame can be compared to a vector embedding of a user prompt by performing a calculation using the vector embeddings. The image-image filter 120 can input the current frame into a light and/or distilled VLM to extract a current frame embedding. The image-image filter 120 can input the last-selected frame into the light and/or distilled VLM to extract a last-selected frame embedding. The image-image filter 120 can determine a semantic image-image similarity score between the current frame and the last-selected frame, for example, by applying a cosine similarity on the current frame embedding and the last-selected frame embedding. The cosine similarity range can be between 0 and 1, where 0 represents no similarity and 1 represents a highest similarity.

The contextual filter 112 can include at least one image-prompt filter 124 to determine a semantic similarity score between a plurality of inputs, such as between a current frame and a context, such as an input prompt. The image-prompt filter 124 can include one or more components as described further herein. The image-prompt filter 124 can receive, as input, a frame such as a current frame and a user prompt. The user prompt can indicate a context. The image-prompt filter 124 can receive the current frame as input, for example, from the decoder 108. The image-prompt filter 124 can receive the context as input, for example, from data sources 104. In some implementations, the current frame is a current frame which was processed and not rejected by the image-image filter 120. The image-prompt filter 124 can input the current frame into a light and/or distilled VLM to extract a current frame embedding. In some implementations, the image-prompt filter 124 can obtain the current frame embedding from the image-image filter 120. The image-prompt filter 124 can input the context into the light and/or distilled VLM to extract a text embedding. The image-prompt filter 124 can determine a semantic image-prompt similarity score between the current frame and the context, for example, by applying a cosine similarity on the current frame embedding and the text embedding. The cosine similarity range can be between 0 and 1, where 0 represents no similarity and 1 represents a highest similarity. It is noted that while this description follows a specific order, the filtering process is not limited to this sequence. The filters 116, 120, 124 can be applied in any order, and an input (e.g., current frame) can also be processed by some or all filters 116, 120, 124 without needing to satisfy specific criteria for progression between them.

The contextual filter 112 can include at least one combined scorer 128 to generate a combined score, which the system 100 can use to determine whether the current frame undergoes further processing, such as by the VLM processor 132. The combined scorer 128 can include one or more components as described further herein. The combined scorer 128 can receive one or more inputs, including a motion score such as that obtained from motion filter 116, a semantic image-image similarity score such as that obtained from image-image filter 120, and/or a semantic image-prompt similarity score, such as that obtained from image-prompt filter 124. The combined scorer 128 can configure one or more weights associated with the one or more inputs. The combined scorer 128 can adjust the one or more weights to adapt the system 100 to various uses. For example, the combined scorer 128 can configure a higher weight associated with the motion score (Wm) relative to the weights associated with the semantic image-image similarity score and the semantic image-prompt similarity score (Ws and Wp, respectively) for an application of the system 100 to surveillance of a warehouse. The combined scorer 128 can combine the one or more weighted inputs to obtain a combined score associated with the current frame. The combined scorer 128 can, responsive to determining that the combined score exceeds a predetermined selection threshold, select the current frame and add the current frame to a set of selected frames. The combined scorer 128 can, responsive to determining that the combined score does not exceed the predetermined selection threshold, reject the current frame. The combined scorer 128 can output the set of selected frames to be used as input to VLM processor 132. By generating a combined score according to the scores from components such as the image-image filter 120, image-prompt filter 124, and/or motion filter 116, the combined scorer 128 can prevent the selection of at least one frame, for example, which, although in response to determining that a motion score corresponding to the frame satisfies a motion threshold and is thereby not rejected by motion filter 116, is yet semantically redundant based on the combined score, indicating that the frame is to be rejected.

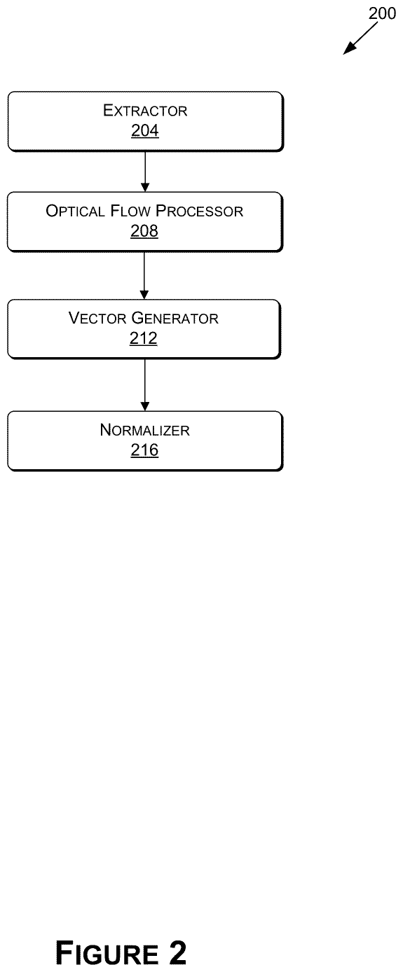

FIG. 2 is a block diagram of a system 200 for optical flow motion filtering. The system 200 can incorporate features of and/or be used to implement one or more components of the system 100, such as motion filter 116.

The system 200 can include at least one extractor 204 to extract a plurality of optical flow points from at least one input frame. The extractor 204 can receive the input frames, for example, from the decoder 108, including a current frame and a last-selected frame. The extractor 204 can extract image derivatives such as spatial and temporal gradients from the current frame and from the last-selected frame. The extractor 204 can generate a plurality of optical flow points of the current frame and a plurality of optical flow points of the last-selected frame based at least on the extracted image derivatives.

The system 200 can include at least one optical flow processor 208 to determine a pixel flow between the optical flow points of a plurality of frames. The optical flow processor 208 can receive, as input, a plurality of optical flow points from the extractor 204. The optical flow processor 208 can apply one or more algorithms such as the Lucas-Kanade algorithm and/or apply one or more neural networks, such as PWC-Net, to determine the pixel flow between the optical flow points of the current frame and a plurality of optical flow points of the last-selected frame. The optical flow processor 208 can output a plurality of values representing the pixel flow between the current frame and the last-selected frame.

The system 200 can include at least one vector generator 212 to generate one or more motion vectors based at least on the pixel flow determined by the optical flow processor 208. The vector generator 212 can receive, as input, a plurality of a plurality of values representing the pixel flow between the current frame and the last-selected frame. The vector generator 212 can generate a plurality of motion vectors that represent the optical flow between the current frame and a last-selected frame. For example, the plurality of motion vectors can indicate the horizontal and vertical movement between the two frames.

The system 200 can include at least one normalizer 216 to normalize the one or more motion vectors generated by the vector generator 212. The normalizer 216 can apply one or more operations to the plurality of motion vectors. The normalizer 216 can determine the magnitude of each motion vector of the plurality of motion vectors. The normalizer 216 can aggregate the magnitude of each motion vector of the plurality of motion vectors to obtain an aggregated magnitude. The normalizer 216 can apply a normalization operation to the aggregated magnitude to determine a motion score between 0 and 1 wherein 0 represents no movement between the current frame and the last-selected frame and 1 represents large changes in movements between the current frame and the last-selected frame.

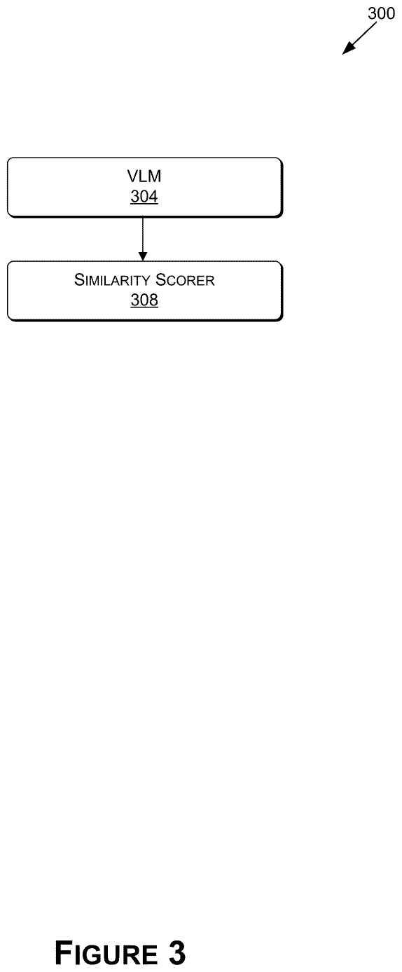

FIG. 3 is a block diagram of a system 300 for semantic similarity image-image filtering. The system 300 can incorporate features of and/or be used to implement one or more components of the system 100, such as image-image filter 120.

The system 300 can include at least one vision language model (VLM) 304 to generate one or more embeddings based at least on one or more input frames. The VLM 304 can be a light and/or distilled VLM. The VLM 304 can receive, as input, one or more input frames, such as a current frame and a last-selected frame, and generate one or more output embeddings, including a vector embedding of the current frame and a vector embedding of the last-selected frame.

The system 300 can include at least one similarity scorer 308 to determine a similarity score between an input image frame and a last-selected image frame. The similarity scorer 308 can receive, as input, a plurality of vector embeddings from VLM 304, such as a vector embedding of the current frame and a vector embedding of the last-selected frame. The similarity scorer 308 can apply a cosine similarity operation on the vector embeddings to determine a semantic image-image similarity score representing the semantic similarity between the current frame and the last-selected frame. The semantic image-image similarity score can be between 0 and 1, where 0 represents no image-image similarity and 1 represents a highest image-image similarity.

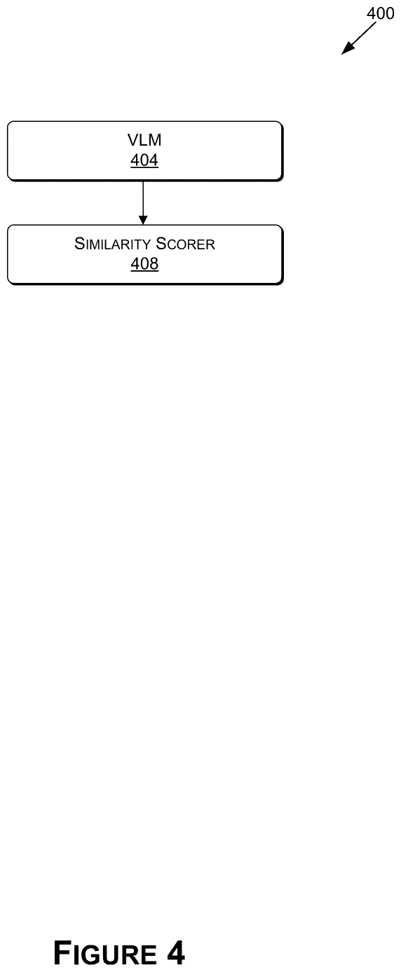

FIG. 4 is a block diagram of a system 400 for semantic similarity image-prompt filtering. The system 400 can incorporate features of and/or be used to implement one or more components of the system 100, such as image-prompt filter 124.

The system 400 can include at least one vision language model (VLM) 404 to generate one or more embeddings based at least on one or more input frames. The VLM 404 can be a light and/or distilled VLM. The VLM 404 can receive one or more inputs, such as a current frame and a context, and generate one or more output embeddings, including a vector embedding of the current frame and a vector embedding of the context.

The system 400 can include at least one similarity scorer 408 to determine a similarity between an input image frame and a user input. The similarity scorer 408 can receive, as input, a plurality of vector embeddings from VLM 404, such as a vector embedding of the current frame and a vector embedding of the context. The similarity scorer 408 can apply a cosine similarity operation on the vector embeddings to determine a semantic image-prompt similarity score representing the semantic similarity between the current frame and the context. The semantic image-prompt similarity score can be between 0 and 1, where 0 represents no image-prompt similarity and 1 represents a highest image-prompt similarity.

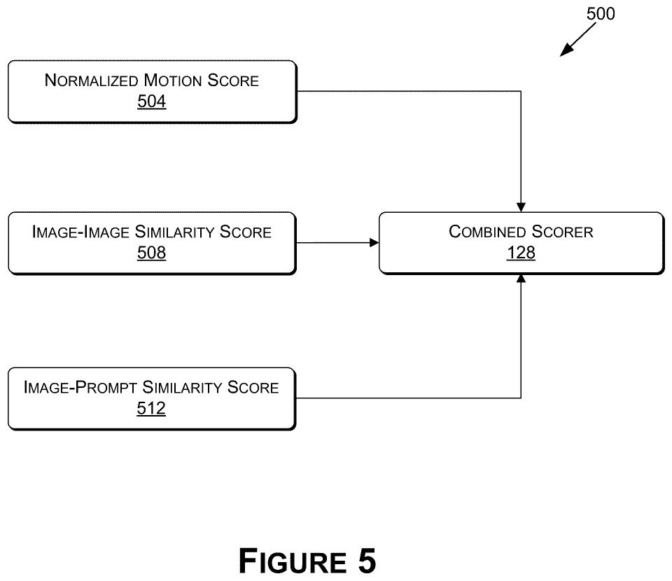

FIG. 5 is a block diagram of a system 500 for generating a combined score of a plurality of inputs. The system 500 can incorporate features of and/or be used to implement one or more components of the system 100, such as combined scorer 128.

The system 500 can include at least one normalized motion score 504, such as that obtained from system 200. The normalized motion score 504 can be a normalized aggregated magnitude of one or more motion vectors, wherein the one or more motion vectors are generated based at least on a plurality of optical flow points representing motion between a first frame and a second frame. The normalized motion score 504 can include an associated weight (e.g., Wm) allowing the system 100 to adapt to specific tasks, such as warehouse surveillance, where a small amount of motion can indicate important information (e.g., theft). The normalized motion score 504 can be used as input into combined scorer 128 to generate a combined score.

The system 500 can include at least one image-image similarity score 508, such as that obtained from system 300. The image-image similarity score 508 can be a semantic similarity score between a first frame and a second frame, wherein the similarity score is determined based at least on comparing vector embeddings of the first frame and the second frame. The image-image similarity score 508 can include an associated weight (e.g., Ws) allowing the system 100 to adapt to specific tasks, such as identifying key events in sports analysis, where a high similarity between frames may not be indicative of semantically redundant frames (e.g., a foot stepping over a field boundary). The image-image similarity score 508 can be used as input into combined scorer 128 to generate a combined score.

The system 500 can include at least one image-prompt similarity score 512, such as that obtained from system 400. The image-prompt similarity score 512 can be a semantic similarity score between a current frame and a context, wherein the similarity score is determined based at least on comparing vector embeddings of the frame and the context. The context can be a user prompt. The image-prompt similarity score 512 can include an associated weight (e.g., Wp) allowing the system 100 to adapt to specific tasks, such as identifying particular objects based on the user prompt. The image-prompt similarity score 512 can be used as input into combined scorer 128 to generate a combined score.

The system 500 can include at least one combined scorer 128 of FIG. 1B to generate a combined score based at least on the normalized motion score 504, the image-image similarity 508, the image-prompt similarity 512, and one or more weights (e.g., combinedScore=(weightₘₒₜᵢₒₙ*motionChange)+(weight_{image}*imageSimilarity)+(weightₚᵣₒₘₚₜ*promptSimilarity)). The combined scorer 128 can select a frame in response to determining that the combined score exceeds a selection threshold. The combined scorer 128 can add the selected frame to a list of selected frames to be used as input, for example, into one or more VLMs.

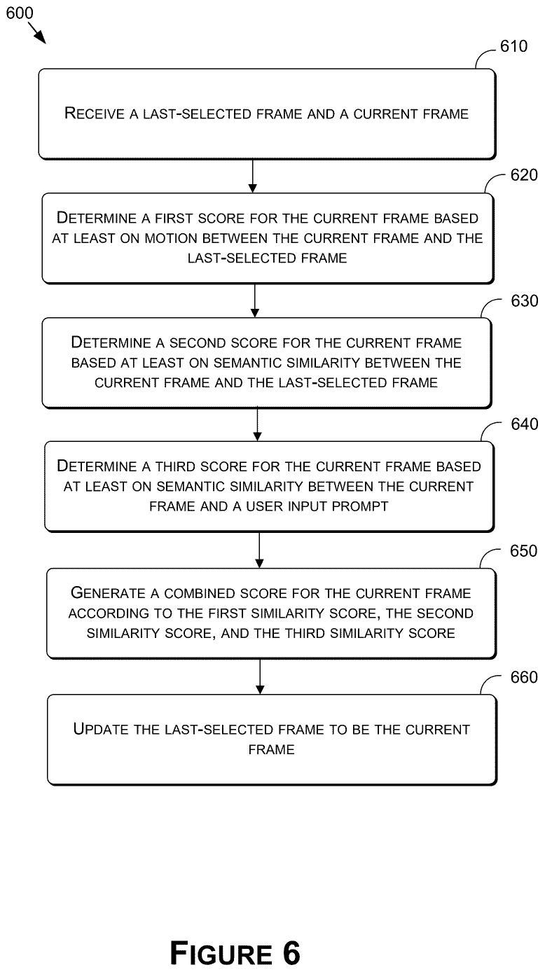

Now referring to FIG. 6, each block of method 600, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, method 600 is described, by way of example, with respect to the system of FIGS. 1A-1B. However, this method may additionally or alternatively be executed by any one system, or any combination of systems, including, but not limited to, those described herein.

FIG. 6 is a flow diagram showing a method 600 for contextual filtering, in accordance with some implementations of the present disclosure. The method 600 can include selecting one or more frames for VLM processing based at least on one or more frame selection criteria. The method 600 can include frame selection criteria such as determining that a motion score of the frame exceeds a motion threshold and determining that a combined score of the frame exceeds a selection threshold.

The method 600, at block 602, can include receiving, as input, a last-selected frame and a current frame. The current frame can be, for example, one of a plurality of decoded frames. The last-selected frame can be stored in memory, for example, with its associated semantic embeddings.

The method 600, at block 620, can include determining a first score for the current frame based at least on motion between the current frame and the last-selected frame. The method 600 can include extracting optical flow points representing the motion between the current frame and the last-selected frame. The method 600 can include generating motion vectors based on the optical flow points and determining their magnitudes. The method 600 can include aggregating the magnitudes of the motion vectors and normalizing the aggregated magnitude to a value between 0 and 1, where 0 represents no movement and 1 represents significant movement between the frames. In response to determining that the first score exceeds a motion threshold, the method 600 can include storing the first score in memory.

The method 600, at block 630, can include determining a second score for the current frame based at least on semantic similarity between the current frame and the last-selected frame. The method 600 can include generating semantic embeddings for the current frame using a vision language model (VLM). The method 600 can include applying a cosine similarity operation on the embeddings to determine the second score. The method 600 can include assigning a higher value to relatively higher similarity between the current frame and the last-selected frame as indicated by the second score. The method 600 can include storing the second score in memory.

The method 600, at block 640, can include determining a third score for the current frame based at least on a semantic similarity between the current frame and a context, such as a user input prompt. The method 600 can include generating embeddings for the prompt using a vision language model (VLM). The method 600 can include applying a cosine similarity operation on the semantic embeddings of the current frame generated at block 630 and the prompt embeddings to determine the third score. The method 600 can include assigning a higher value to relatively higher similarity between the current frame and the context as indicated by the third score. The method 600 can include storing the third score in memory.

The method 600, at block 650, can include generating a combined score for the current frame according to the first score, the second score, and the third score. The method 600 can include weighting one or more of the first score, the second score, and the third score. The method can include selecting the current frame for further processing in response to determining that the combined score satisfies a threshold. For example, in response to determining that the combined score exceeds the threshold, the method 600 can include adding the current frame to a list of selected frames to be used, for example, for video processing and/or VLM processing.

The method 600, at block 660, can include updating the last-selected frame to be the current frame. For example, the method can include updating the last-selected frame semantic embeddings to be the semantic embeddings of the current frame.

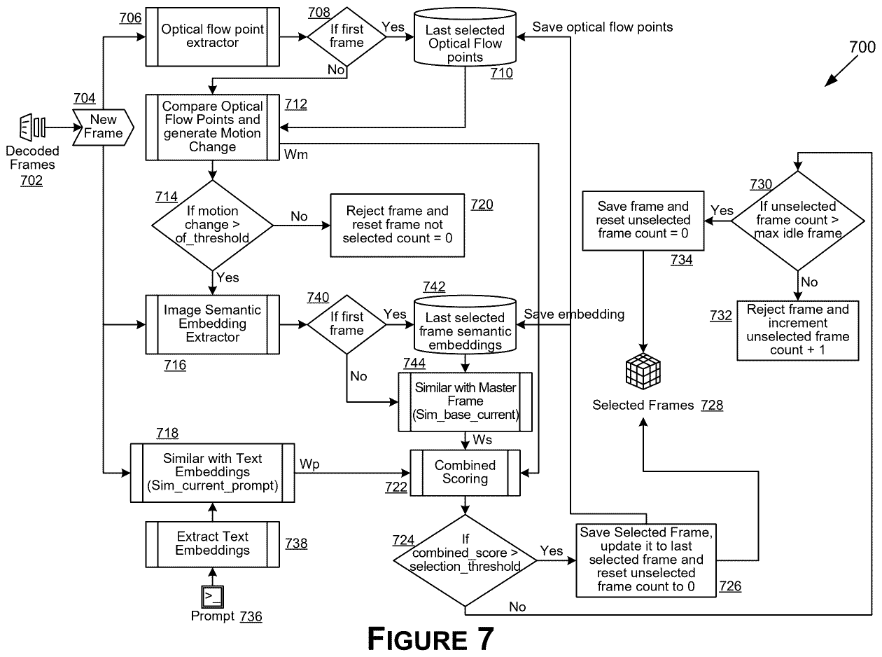

Now referring to FIG. 7, each block of method 700, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, method 700 is described, by way of example, with respect to the system of FIGS. 1A-1B. However, this method may additionally or alternatively be executed by any one system, or any combination of systems, including, but not limited to, those described herein.

FIG. 7 is a flow diagram showing a method 700 for contextual filtering, in accordance with some implementations of the present disclosure. The method 700 can include storing a count of unselected frames. The method 700 can include initializing the count of unselected frames as zero.

The method 700 can include inputting a new frame 704 of a plurality of decoded frames 702 to optical flow point extractor 706.

The method 700 can include, responsive to the new frame 704 being a first frame, saving the new frame in memory 710 as last-selected frame optical flow points.

The method 700, at block 712, can include comparing optical flow points of the new frame 704 and the last-selected optical flow points in memory 710 and generating a motion change based at least on the optical flow points.

The method 700, at block 716, can include, responsive to determining at block 714 that the motion change determined at block 712 exceeds a threshold, extracting semantic embeddings of the new frame 704.

The method 700, at block 720, can include, responsive to determining at block 714 that the motion change determined at block 712 does not exceed the threshold, rejecting the new frame 704 and resetting the count of unselected frames to zero.

The method 700 can include, responsive to determining that the new frame 704 is a first frame at block 740, saving the semantic embeddings determined at block 716 in memory 742 as last-selected frame semantic embeddings.

The method 700, at block 744, can include determining a similarity between the new frame 704 semantic embeddings and the last-selected frame semantic embeddings.

The method 700 can include receiving, as input, at least one user prompt 736. The user prompt 736 can indicate a context. The method can include, at block 738, extracting text embeddings of the user prompt 736.

The method 700 can include, at block 718, determining a similarity between the new frame 704 and the text embeddings of the user prompt 736.

The method 700 can include, at block 722, generating a combined score using a normalized weighted motion change determined at block 712, a weighted similarity between the new frame 704 semantic embeddings and the last-selected frame semantic embeddings stored in memory 742, and a weighted similarity between the new frame 704 and the text embeddings of the user prompt 736 determined at block 718.

The method 700 can include, at block 726, responsive to determining that the combined score generated at block 722 exceeds a selection threshold, updating a selected frame in memory as the last-selected frame, saving the last-selected frame embedding in memory 742, saving the new frame 704 as a selected frame of selected frames 728, and resetting the count of unselected frames to zero.

The method 700 can include, at block 734, responsive to determining that the combined score generated at block 722 does not exceed a selection threshold, and determining that the count of unselected frames exceeds a maximum idle frame threshold at block 730, saving the new frame 704 as a selected frame of selected frames 728, and resetting the count of unselected frames to zero.

The method 700 can include, at block 732, responsive to determining that the combined score generated at block 722 does not exceed a selection threshold, and determining that the count of unselected frames does not exceed a maximum idle frame threshold at block 730, rejecting the new frame 704 and incrementing the count of unselected frames by one.

### Example Language Models

In at least some implementations, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based at least on the context provided in input prompts or queries. These language models may be considered “large,” in implementations, based at least on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in implementations, whereas in other implementations, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various implementations. For example, different architectures may be implemented that use different techniques for understanding and generating outputs-such as text, audio, video, image, 2D and/or 3D design or asset data, etc. In some implementations, LLMs/SLMs/VLMs/MMLMs/etc. architectures such as recurrent neural networks (RNNs) or long short-term memory networks (LSTMs) may be used, while in other implementations transformer architectures—such as those that rely on self-attention and/or cross-attention (e.g., between contextual data and textual data) mechanisms-may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein-may be implemented depending on the particular implementation and the task(s) being performed using the LLMs/SLMs/VLMs/MMLMs/etc.

In various implementations, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in implementations, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/SLMs/VLMs/MMLMs/etc. of the present disclosure may be implemented using various model alignment techniques. For example, in some implementations, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some implementations, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some implementations, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based at least on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some implementations, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data may be provided with the same input query and prompt (e.g., set of constraints, conditioners, etc.). In one or more implementations, the language models may be different versions of the same foundation model. In one or more implementations, at least one language model may be instantiated as multiple agents—e.g., more than one prompt may be provided to constrain, direct, or otherwise influence a style, a content, or a character, etc., of the output provided. In one or more example, non-limiting implementations, the same language model may be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more implementations, the output from one language model—or version, instance, or agent—maybe be provided as input to another language model for further processing and/or validation. In one or more implementations, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more implementations, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 8A is a block diagram of an example generative language model system 800 suitable for use in implementing at least some implementations of the present disclosure. In the example illustrated in FIG. 8A, the generative language model system 800 includes a retrieval augmented generation (RAG) component 892, an input processor 805, a tokenizer 810, an embedding component 820, plug-ins/APIs 895, and a generative language model (LM) 830 (which may include an LLM, a SLM, a VLM, a MMLM, etc.).

At a high level, the input processor 805 may receive an input 801 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 830 (e.g., LLM/SLM/VLM/MMLM/etc.). In some implementations, the input 801 includes plain text in the form of one or more sentences, paragraphs, and/or documents. Additionally or alternatively, the input 801 may include numerical sequences, precomputed embeddings (e.g., word or sentence embeddings), and/or structured data (e.g., in tabular formats, JSON, or XML). In some implementations in which the generative LM 830 is capable of processing multi-modal inputs, the input 801 may combine text (or may omit text) with image data, audio data, video data, design data, USD data, and/or other types of input data, such as but not limited to those described herein. Taking raw input text as an example, the input processor 805 may prepare raw input text in various ways. For example, the input processor 805 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 805 may remove stopwords to reduce noise and focus the generative LM 830 on more meaningful content. The input processor 805 may apply text normalization, for example, by converting all characters to lowercase, removing accents, and/or or handling special cases like contractions or abbreviations to ensure consistency. These are just a few examples, and other types of input processing may be applied.

In some implementations, a RAG component 892 (which may include one or more RAG models, and/or may be performed using the generative LM 830 itself) may be used to retrieve additional information to be used as part of the input 801 or prompt. RAG may be used to enhance the input to the LLM/SLM/VLM/MMLM/etc. with external knowledge, so that answers to specific questions or queries or requests are more relevant—such as in a case where specific knowledge is required. The RAG component 892 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some implementations, the input 801 may be generated using the query or input to the model (e.g., a question, a request, etc.) in addition to data retrieved using the RAG component 892. In some implementations, the input processor 805 may analyze the input 801 and communicate with the RAG component 892 (or the RAG component 892 may be part of the input processor 805, in implementations) in order to identify relevant text and/or other data to provide to the generative LM 830 as additional context or sources of information from which to identify the response, answer, or output 890, generally. For example, where the input indicates that the user is interested in a desired tire pressure for a particular make and model of vehicle, the RAG component 892 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 892 may retrieve a prior stored conversation history—or at least a summary thereof—and include the prior conversation history along with the current ask/request as part of the input 801 to the generative LM 830.

The RAG component 892 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 892 and the embeddings of the chunks along with the embeddings of the query may be compared to identify the most similar/related embeddings to the query, which may be supplied to the generative LM 830 to generate an output.

In some implementations, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents-which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such implementations, may contain relevant textual content and metadata about the knowledge graph as well as be integrated with a vector database. In some implementations, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some implementations, graph RAG (e.g., using a graph database) may be combined with standard (e.g., vector database) RAG, and/or other RAG types, to benefit from multiple approaches.

In any implementations, the RAG component 892 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 810 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 830 to understand morphological variations and handle out-of-vocabulary words more effectively. Character-based tokenization represents each character as a separate token, enabling the generative LM 830 to process text at a fine-grained level. The choice of tokenization strategy may depend on factors such as the language being processed, the task at hand, and/or characteristics of the training dataset. As such, the tokenizer 810 may convert the (e.g., processed) text into a structured format according to tokenization schema being implemented in the particular implementation.

The embedding component 820 may use any known embedding technique to transform discrete tokens into (e.g., dense, continuous vector) representations of semantic meaning. For example, the embedding component 820 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 801 includes image data/video data/etc., the input processor 801 may resize the data to a standard size compatible with format of a corresponding input channel and/or may normalize pixel values to a common range (e.g., 0 to 1) to ensure a consistent representation, and the embedding component 820 may encode the image data using any known technique (e.g., using one or more convolutional neural networks (CNNs) to extract visual features). In some implementations in which the input 801 includes audio data, the input processor 801 may resample an audio file to a consistent sampling rate for uniform processing, and the embedding component 820 may use any known technique to extract and encode audio features-such as in the form of a spectrogram (e.g., a mel-spectrogram). In some implementations in which the input 801 includes video data, the input processor 801 may extract frames or apply resizing to extracted frames, and the embedding component 820 may extract features such as optical flow embeddings or video embeddings and/or may encode temporal information or sequences of frames. In some implementations in which the input 801 includes multi-modal data, the embedding component 820 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 830 and/or other components of the generative LM system 800 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 820 may apply an encoded representation of the input 801 to the generative LM 830, and the generative LM 830 may process the encoded representation of the input 801 to generate an output 890, which may include responsive text and/or other types of data.

As described herein, in some implementations, the generative LM 830 may be configured to access or use—or capable of accessing or using—plug-ins/APIs 895 (which may include one or more plug-ins, application programming interfaces (APIs), databases, data stores, repositories, etc.). For example, for certain tasks or operations that the generative LM 830 is not ideally suited for, the model may have instructions (e.g., as a result of training, and/or based at least on instructions in a given prompt, such as those retrieved using the RAG component 892) to access one or more plug-ins/APIs 895 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 895 to the plug-in/API 895, the plug-in/API 895 may process the information and return an answer to the generative LM 830, and the generative LM 830 may use the response to generate the output 890. This process may be repeated—e.g., recursively—for any number of iterations and using any number of plug-ins/APIs 895 until an output 890 that addresses each ask/question/request/process/operation/etc. from the input 801 can be generated. As such, the model(s) may not only rely on its own knowledge from training on a large dataset(s) and/or from data retrieved using the RAG component 892, but also on the expertise or optimized nature of one or more external resources—such as the plug-ins/APIs 895.

FIG. 8B is a block diagram of an example implementation in which the generative LM 830 includes a transformer encoder-decoder. For example, assume input text such as “Who discovered gravity” is tokenized (e.g., by the tokenizer 410 of FIG. 8A) into tokens such as words, and each token is encoded (e.g., by the embedding component 820 of FIG. 8A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 835 of the generative LM 830.

In an example implementation, the encoder(s) 835 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 840 may convert the context vector into attention vectors (keys and values) for the decoder(s) 845.

In an example implementation, the decoder(s) 845 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 835, in an example transformer architecture, each token (e.g., word) flows through a separate path in the decoder(s) 845. During a first pass, the decoder(s) 845, a classifier 850, and a generation mechanism 855 may generate a first token, and the generation mechanism 855 may apply the generated token as an input during a second pass. The process may repeat in a loop, successively generating and adding tokens (e.g., words) to the output from the preceding pass and applying the token embeddings of the composite sequence with positional encodings as an input to the decoder(s) 845 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 835, except that it creates its queries from the layer below it and takes the keys and values (e.g., matrix) from the output of the encoder(s) 835.

As such, the decoder(s) 845 may output some decoded (e.g., vector) representation of the input being applied during a particular pass. The classifier 850 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 855 may select or sample a word or token based at least on a corresponding predicted probability (e.g., select the word with the highest predicted probability) and append it to the output from a previous pass, generating each word or token sequentially. The generation mechanism 855 may repeat the process, triggering successive decoder inputs and corresponding predictions until selecting or sampling a symbol or token that represents the end of the response, at which point, the generation mechanism 855 may output the generated response.

FIG. 8C is a block diagram of an example implementation in which the generative LM 830 includes a decoder-only transformer architecture. For example, the decoder(s) 860 of FIG. 8C may operate similarly as the decoder(s) 845 of FIG. 8B except each of the decoder(s) 860 of FIG. 8C omits the encoder-decoder self-attention layer (since there is no encoder in this implementation). As such, the decoder(s) 860 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 860. As with the decoder(s) 845 of FIG. 8B, each token (e.g., word) may flow through a separate path in the decoder(s) 860, and the decoder(s) 860, a classifier 865, and a generation mechanism 870 may use auto-regression to sequentially generate one token at a time until predicting a symbol or token that represents the end of the response. The classifier 865 and the generation mechanism 870 may operate similarly as the classifier 850 and the generation mechanism 855 of FIG. 8B, with the generation mechanism 870 selecting or sampling each successive output token based at least on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Content Streaming System

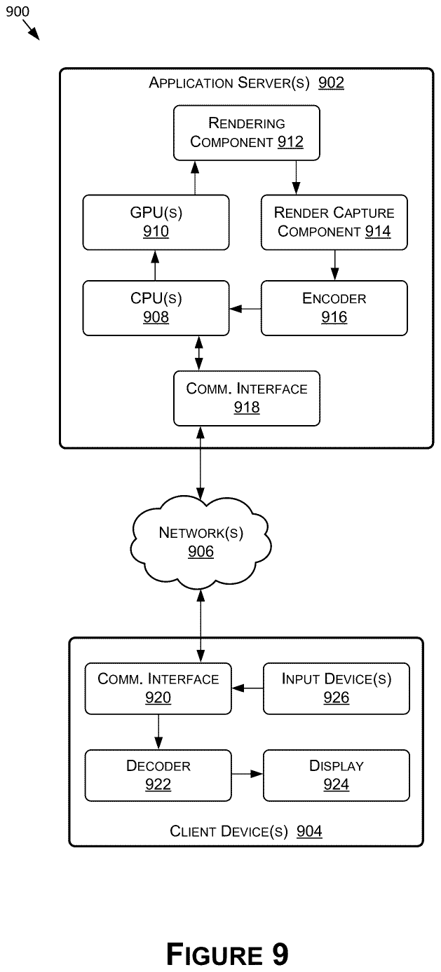

Now referring to FIG. 9, FIG. 9 is an example system diagram for a content streaming system 900, in accordance with some implementations of the present disclosure. FIG. 9 includes application server(s) 902 (which can include similar components, features, and/or functionality to the example computing device 1000 of FIG. 10), client device(s) 904 (which can include similar components, features, and/or functionality to the example computing device 1000 of FIG. 10), and network(s) 906 (which can be similar to the network(s) described herein). In some implementations of the present disclosure, the system 900 can be implemented. The application session can correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 900, for an application session, the client device(s) 904 can only receive input data in response to inputs to the input device(s), transmit the input data to the application server(s) 902, receive encoded display data from the application server(s) 902, and display the display data on the display 924. As such, the more computationally intense computing and processing is offloaded to the application server(s) 902 (e.g., rendering—in particular ray or path tracing—for graphical output of the application session is executed by the GPU(s) of the game server(s) 902). In other words, the application session is streamed to the client device(s) 904 from the application server(s) 902, thereby reducing the requirements of the client device(s) 904 for graphics processing and rendering.

For example, with respect to an instantiation of an application session, a client device 904 can be displaying a frame of the application session on the display 924 based at least on receiving the display data from the application server(s) 902. The client device 904 can receive an input to one of the input device(s) and generate input data in response. The client device 904 can transmit the input data to the application server(s) 902 via the communication interface 920 and over the network(s) 906 (e.g., the Internet), and the application server(s) 902 can receive the input data via the communication interface 918. The CPU(s) can receive the input data, process the input data, and transmit data to the GPU(s) that causes the GPU(s) to generate a rendering of the application session. For example, the input data can be representative of a movement of a character of the user in a game session of a game application, firing a weapon, reloading, passing a ball, turning a vehicle, etc. The rendering component 912 can render the application session (e.g., representative of the result of the input data) and the render capture component 914 can capture the rendering of the application session as display data (e.g., as image data capturing the rendered frame of the application session). The rendering of the application session can include ray or path-traced lighting and/or shadow effects, computed using one or more parallel processing units—such as GPUs, which can further employ the use of one or more dedicated hardware accelerators or processing cores to perform ray or path-tracing techniques—of the application server(s) 902. In some implementations, one or more virtual machines (VMs)—e.g., including one or more virtual components, such as vGPUs, vCPUs, etc.—can be used by the application server(s) 902 to support the application sessions. The encoder 916 can then encode the display data to generate encoded display data and the encoded display data can be transmitted to the client device 904 over the network(s) 906 via the communication interface 918. The client device 904 can receive the encoded display data via the communication interface 920 and the decoder 922 can decode the encoded display data to generate the display data. The client device 904 can then display the display data via the display 924.

The systems and methods described herein can be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed implementations can be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 10 is a block diagram of an example computing device(s) 1000 suitable for use in implementing some implementations of the present disclosure. Computing device 1000 can include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one implementation, the computing device(s) 1000 can comprise one or more virtual machines (VMs), and/or any of the components thereof can comprise virtual components (e.g., virtual hardware components). For non-limiting examples, one or more of the GPUs 1008 can comprise one or more vGPUs, one or more of the CPUs 1006 can comprise one or more vCPUs, and/or one or more of the logic units 1020 can comprise one or more virtual logic units. As such, a computing device(s) 1000 can include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some implementations, a presentation component 1018, such as a display device, can be considered an I/O component 1014 (e.g., if the display is a touch screen). As another example, the CPUs 1006 and/or GPUs 1008 can include memory (e.g., the memory 1004 can be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 can represent one or more links or busses, such as an address bus, a data bus, a control bus, or a combination thereof. The interconnect system 1002 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 1006 can be directly connected to the memory 1004. Further, the CPU 1006 can be directly connected to the GPU 1008. Where there is direct, or point-to-point connection between components, the interconnect system 1002 can include a PCIe link to carry out the connection. In these examples, a PCI bus need not be included in the computing device 1000.

The memory 1004 can include any of a variety of computer-readable media. The computer-readable media can be any available media that can be accessed by the computing device 1000. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 1004 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1000. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 1006 can be configured to execute at least some of the computer-readable instructions to control one or more components of the computing device 1000 to perform one or more of the methods and/or processes described herein. The CPU(s) 1006 can each include one or more cores (e.g., one, two, four, eight, twenty-eight, seventy-two, etc.) that are capable of handling a multitude of software threads simultaneously. The CPU(s) 1006 can include any type of processor, and can include different types of processors depending on the type of computing device 1000 implemented (e.g., processors with fewer cores for mobile devices and processors with more cores for servers). For example, depending on the type of computing device 1000, the processor can be an Advanced RISC Machines (ARM) processor implemented using Reduced Instruction Set Computing (RISC) or an x86 processor implemented using Complex Instruction Set Computing (CISC). The computing device 1000 can include one or more CPUs 1006 in addition to one or more microprocessors or supplementary co-processors, such as math co-processors.

In addition to or alternatively from the CPU(s) 1006, the GPU(s) 1008 can be configured to execute at least some of the computer-readable instructions to control one or more components of the computing device 1000 to perform one or more of the methods and/or processes described herein. One or more of the GPU(s) 1008 can be an integrated GPU (e.g., with one or more of the CPU(s) 1006 and/or one or more of the GPU(s) 1008 can be a discrete GPU. In implementations, one or more of the GPU(s) 1008 can be a coprocessor of one or more of the CPU(s) 1006. The GPU(s) 1008 can be used by the computing device 1000 to render graphics (e.g., 3D graphics) or perform general purpose computations. For example, the GPU(s) 1008 can be used for General-Purpose computing on GPUs (GPGPU). The GPU(s) 1008 can include hundreds or thousands of cores that are capable of handling hundreds or thousands of software threads simultaneously. The GPU(s) 1008 can generate pixel data for output images in response to rendering commands (e.g., rendering commands from the CPU(s) 1006 received via a host interface). The GPU(s) 1008 can include graphics memory, such as display memory, for storing pixel data or any other suitable data, such as GPGPU data. The display memory can be included as part of the memory 1004. The GPU(s) 1008 can include two or more GPUs operating in parallel (e.g., via a link). The link can directly connect the GPUs (e.g., using NVLINK) or can connect the GPUs through a switch (e.g., using NVSwitch). When combined together, each GPU 1008 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 1006 and/or the GPU(s) 1008, the logic unit(s) 1020 can be configured to execute at least some of the computer-readable instructions to control one or more components of the computing device 1000 to perform one or more of the methods and/or processes described herein. In implementations, the CPU(s) 1006, the GPU(s) 1008, and/or the logic unit(s) 1020 can discretely or jointly perform any combination of the methods, processes and/or portions thereof. One or more of the logic units 1020 can be part of and/or integrated in one or more of the CPU(s) 1006 and/or the GPU(s) 1008 and/or one or more of the logic units 1020 can be discrete components or otherwise external to the CPU(s) 1006 and/or the GPU(s) 1008. In implementations, one or more of the logic units 1020 can be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 can include one or more receivers, transmitters, and/or transceivers that enable the computing device 1000 to communicate with other computing devices via an electronic communication network, included wired and/or wireless communications. The communication interface 1010 can include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 1020 and/or communication interface 1010 can include one or more data processing units (DPUs) to transmit data received over a network and/or through interconnect system 1002 directly to (e.g., a memory of) one or more GPU(s) 1008.

The I/O ports 1012 can enable the computing device 1000 to be logically coupled to other devices including the I/O components 1014, the presentation component(s) 1018, and/or other components, some of which can be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 can be include depth cameras, such as stereoscopic camera systems, infrared camera systems, RGB camera systems, touchscreen technology, and combinations of these, for gesture detection and recognition. Additionally, the computing device 1000 can include accelerometers or gyroscopes (e.g., as part of an inertia measurement unit (IMU)) that enable detection of motion. In some examples, the output of the accelerometers or gyroscopes can be used by the computing device 1000 to render immersive augmented reality or virtual reality.

The power supply 1016 can include a hard-wired power supply, a battery power supply, or a combination thereof. The power supply 1016 can provide power to the computing device 1000 to enable the components of the computing device 1000 to operate.

The presentation component(s) 1018 can include a display (e.g., a monitor, a touch screen, a television screen, a heads-up-display (HUD), other display types, or a combination thereof), speakers, and/or other presentation components. The presentation component(s) 1018 can receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that can be used in at least one implementations of the present disclosure. The data center 1100 can include a data center infrastructure layer 1110, a framework layer 1120, a software layer 1130, and/or an application layer 1140.

As shown in FIG. 11, the data center infrastructure layer 1110 can include a resource orchestrator 1112, grouped computing resources 1114, and node computing resources (“node C.R.s”) 1116(1)-1116(N), where “N” represents any whole, positive integer. In at least one implementation, node C.R.s 1116(1)-1116(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 1116(1)-1116(N) can correspond to a server having one or more of the above-mentioned computing resources. In addition, in some implementations, the node C.R.s 1116(1)-1116(N) can include one or more virtual components, such as vGPUs, vCPUs, and/or the like, and/or one or more of the node C.R.s 1116(1)-1116(N) can correspond to a virtual machine (VM).

In at least one implementation, grouped computing resources 1114 can include separate groupings of node C.R.s 1116 housed within one or more racks (not shown), or many racks housed in data centers at various geographical locations (also not shown). Separate groupings of node C.R.s 1116 within grouped computing resources 1114 can include grouped compute, network, memory or storage resources that can be configured or allocated to support one or more workloads. In at least one implementation, several node C.R.s 1116 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 1112 can configure or otherwise control one or more node C.R.s 1116(1)-1116(N) and/or grouped computing resources 1114. In at least one implementation, resource orchestrator 1112 can include a software design infrastructure (SDI) management entity for the data center 1100. The resource orchestrator 1112 can include hardware, software, or some combination thereof.

In at least one implementation, as shown in FIG. 11, framework layer 1120 can include a job scheduler 1128, a configuration manager 1134, a resource manager 1136, and/or a distributed file system 1138. The framework layer 1120 can include a framework to support software 1132 of software layer 1130 and/or one or more application(s) 1142 of application layer 1140. The software 1132 or application(s) 1142 can respectively include web-based service software or applications, such as those provided by Amazon Web Services, Google Cloud and Microsoft Azure. The framework layer 1120 can be, but is not limited to, a type of free and open-source software web application framework such as Apache Spark™ (hereinafter “Spark”) that can utilize distributed file system 1138 for large-scale data processing (e.g., “big data”). In at least one implementation, job scheduler 1128 can include a Spark driver to facilitate scheduling of workloads supported by various layers of data center 1100. The configuration manager 1134 can be capable of configuring different layers such as software layer 1130 and framework layer 1120 including Spark and distributed file system 1138 for supporting large-scale data processing. The resource manager 1136 can be capable of managing clustered or grouped computing resources mapped to or allocated for support of distributed file system 1138 and job scheduler 1128. In at least one implementation, clustered or grouped computing resources can include grouped computing resource 1114 at data center infrastructure layer 1110. The resource manager 1136 can coordinate with resource orchestrator 1112 to manage these mapped or allocated computing resources.

In at least one implementation, software 1132 included in software layer 1130 can include software used by at least portions of node C.R.s 1116(1)-1116(N), grouped computing resources 1114, and/or distributed file system 1138 of framework layer 1120. One or more types of software can include, but are not limited to, Internet web page search software, e-mail virus scan software, database software, and streaming video content software.

In at least one implementation, application(s) 1142 included in application layer 1140 can include one or more types of applications used by at least portions of node C.R.s 1116(1)-1116(N), grouped computing resources 1114, and/or distributed file system 1138 of framework layer 1120. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 1134, resource manager 1136, and resource orchestrator 1112 can implement any number and type of self-modifying actions based at least on any amount and type of data acquired in any technically feasible fashion. Self-modifying actions can relieve a data center operator of data center 1100 from making possibly bad configuration decisions and possibly avoiding underutilized and/or poor performing portions of a data center.

The data center 1100 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 1100. In at least one implementation, trained or deployed machine learning models corresponding to one or more neural networks can be used to infer or predict information using resources described above with respect to the data center 1100 by using weight parameters calculated through one or more training techniques, such as but not limited to those described herein.

In at least one implementation, the data center 1100 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 1000 of FIG. 10—e.g., each device can include similar components, features, and/or functionality of the computing device(s) 1000. In addition, where backend devices (e.g., servers, NAS, etc.) are implemented, the backend devices can be included as part of a data center 1100, an example of which is described in more detail herein with respect to FIG. 11.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server may not be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 1000 described herein with respect to FIG. 10. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising one or more circuits to:
detect a motion between a first frame of image data and a second frame of image data;
determine a first similarity score between the first frame and the second frame and a second similarity score between the second frame and a context for processing of the second frame; and
process the second frame using one or more neural networks responsive to determining that one or more frame selection criteria are satisfied based at least on the motion, the first similarity score, and the second similarity score.

2. The one or more processors of claim 1, wherein the one or more circuits are to determine the context according to a user prompt indicative of the context.

3. The one or more processors of claim 1, wherein the one or more circuits are to detect the motion between the first frame and the second frame according to an optical flow of the first frame relative to the second frame.

4. The one or more processors of claim 1, wherein the one or more circuits are to:
retrieve the first frame as a selected frame; and
update the selected frame to be the second frame responsive to determining that the one or more frame selection criteria are satisfied.

5. The one or more processors of claim 1, wherein the one or more circuits are to determine the first similarity score by:
determining, using at least one language model, a first semantic embedding of the first frame, and a second semantic embedding of the second frame; and
comparing the first semantic embedding with the second semantic embedding.

6. The one or more processors of claim 1, wherein the one or more circuits are to determine that the one or more frame selection criteria are satisfied based at least on assigning a higher value to relatively higher similarity between the first frame and the second frame as indicated by the first similarity score and to relatively higher similarity between the second frame and the context as indicated by the second similarity score.

7. The one or more processors of claim 1, wherein the one or more circuits are to reject, in response to determining that the first similarity score is below a similarity threshold, the second frame from further processing.

8. The one or more processors of claim 1, wherein the one or more circuits are to reject, in response to determining that the motion is less than a motion threshold, the second frame from further processing.

9. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

10. A system, comprising:
one or more processors to execute operations comprising:
detecting a motion between a first frame of image data and a second frame of image data;
determining a first similarity score between the first frame and the second frame and a second similarity score between the second frame and a context for processing of the second frame; and
processing the second frame using one or more neural networks responsive to determining that one or more frame selection criteria are satisfied based at least on the motion, the first similarity score, and the second similarity score.

11. The system of claim 10, wherein the one or more processors are to execute operations comprising:
determining that the one or more frame selection criteria are satisfied based at least on:
assigning a higher value to relatively higher similarity between the first frame and the second frame as indicated by the first similarity score and to relatively higher similarity between the second frame and the context as indicated by the second similarity score;
generating a combined score based at least on the motion, the first similarity score, and the second similarity score; and
determining that the combined score satisfies a threshold; and
responsive to determining that the one or more frame selection criteria are satisfied, processing the second frame using one or more neural networks.

12. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

13. A method, comprising:
receiving, as input, a last-selected frame and a current frame;
determining, using optical flow, a first score for the current frame based at least on motion between the current frame and the last-selected frame;
determining a second score for the current frame based at least on a semantic similarity between the current frame and the last-selected frame;
generating a combined score for the current frame based at least on the first score and the second score;
selecting the current frame for further processing in response to determining that the combined score satisfies a threshold; and
updating the last-selected frame to be the current frame.

14. The method of claim 13, comprising:
generating the combined score according to a third score for the current frame based at least on a semantic similarity between the current frame and a user input prompt; and
weighting one or more of the first score, the second score, and the third score.

15. The method of claim 13, further comprising storing, responsive to the current frame being a first frame, the current frame in memory as a last-selected frame.

16. The method of claim 13 wherein, responsive to determining that the first score does not exceed a threshold, rejecting the current frame from further processing.

17. The method of claim 13 further comprising, responsive to determining that the second score does not exceed a threshold:
rejecting the current frame from further processing; and
incrementing a count of unselected frames.

18. The method of claim 13, wherein selecting the current frame further comprises resetting a count of unselected frames to zero.

19. The method of claim 13 wherein, responsive to determining that a count of unselected frames exceeds a second threshold:
selecting the current frame for further processing; and
resetting the count of unselected frames to zero.

20. The method of claim 13, wherein, responsive to determining that the combined score does not satisfy the threshold and that a count of unselected frames does not exceed a second threshold:
rejecting the current frame from further processing; and
incrementing the count of unselected frames.
